(19) United States
(12) Patent Application Publication
(10) Pub. No.: US 2011/0273641 A1
(43) Pub. Date: Nov. 10, 2011

(54) LIQUID CRYSTAL DISPLAY DEVICE AND FRAME FOR LIQUID CRYSTAL DISPLAY DEVICE

(75) Inventors: Eriko Wakabayashi, Osaka-shi (JP); Takafumi Hara, Osaka-shi (JP); Masanori Shimo, Osaka-shi (JP); Saori Nambo, Osaka-shi (JP)

(73) Assignee: SHARP KABUSHIKI KAISHA, Osaka-shi, Osaka (JP)

(21) Appl. No.: 13/144,296

(22) PCT Filed: Oct. 30, 2009
(86) PCT No.: PCT/JP2009/068700

§ 371 Date: Jul. 13, 2011

(30) Foreign Application Priority Data
Jan. 14, 2009 (JP) 2009-006103

(51) Int. Cl. G02F 1/1333

(52) U.S. Cl. 349/58

(57) ABSTRACT

In a liquid crystal display device provided by the present invention, in a coupling part in which a plurality of frame components 32 and 42 forming a frame are coupled to each other, a part 53 of an end 50A of one of the frame components, i.e., the frame component 32, and a part 55 of an end 50B of the other frame component 42 overlap each other in a front-rear direction of the liquid crystal panel. Among the overlapping two ends 50A and 50B, the end facing an optical member 78 (member receiving portion 55) is close to the optical member 78, and is formed to be contactable with the optical member 78 in a surface-to-surface manner when the coupling part is bent toward the optical member 78.

### TECHNICAL FIELD

The present invention relates to a liquid crystal display device and a frame for, and mountable on, the liquid crystal display device.

### BACKGROUND ART

Recently, liquid crystal display devices are in wide use as image display devices (displays) for TVs, personal computers and the like. Such a liquid crystal display device typically includes a rectangular liquid crystal panel as a liquid crystal screen for displaying an image.

In such a liquid crystal display device including a liquid crystal panel, a frame is located on a rear (back) side of the liquid crystal panel, more specifically, between the panel and a backlight device, which is a light source for the panel. The liquid crystal panel is placed on a top surface of the frame. On a front side of the liquid crystal panel, a frame-like bezel is located. The bezel and the frame each have a shape which surrounds a rectangular display area (active area) located in a central area of the liquid crystal panel, and hold a rectangular-like peripheral portion of the liquid crystal panel from the front side and the rear side of the panel.

Recently, such liquid crystal display devices have been progressively increased in size. In accordance with such an increase in size, the bezel and the frame holding the liquid crystal panel have also been increased in size. For example, as described in Patent Document 1, a liquid crystal display device reduced in weight by including a frame also acting as a case (chassis) of the backlight device has been proposed.

### CITATION LIST

### Patent Document

Patent Document 1: Japanese Patent Laid-Open Publication No. 2007-310406

### SUMMARY OF THE INVENTION

### Technical Problem

A frame used for a large size liquid crystal display device is preferably formed using a small mold in order to reduce the cost. Typically, a large size frame is produced by forming a plurality of frame components using a mold and coupling the obtained frame components to each other.

An example of frame component used to form such a frame has an L shape as seen in a plan view, which is obtainable by dividing a rectangular-like frame into four such that each frame component has each one of the four corners of the frame. This frame component typically includes a front frame portion located to cover a front peripheral portion of the liquid crystal panel and a side frame portion provided to rise perpendicularly from an outer edge of the front frame portion so as to cover an outer side surface of the panel.

Typically in a coupling part in which two frame components having the above-described structure are coupled to each other, an end (a part thereof) of one of the frame components overlaps an end (a part of) of the other frame component. A stopper portion provided in one of the frame components is engaged with an engageable portion provided in the other frame component in the overlapping portion, and thus the coupling structure is formed.

An example of such a coupling structure will be described with reference to FIG. 11A through FIG. 11D. FIG. 11A(a) schematically shows an outer surface of each of side frame portions 234 and 244 of two frame components 232 and 242 before a coupling structure 250 is formed. FIG. 11A(b) schematically shows an inner surface of each of the side frame portions 234 and 244 of the two frame components 232 and 242 before the coupling structure 250 is formed. FIG. 11B(a) schematically shows the outer surface of the side frame portions 234 and 244 in a state where the coupling structure 250 is formed and the two frame components 232 and 242 are coupled to each other. FIG. 11B(b) schematically shows the inner surface of the side frame portions 234 and 244 in a state where the coupling structure 250 is formed and the two frame components 232 and 242 are coupled to each other. FIG. 11C(a) schematically shows the outer surface of the side frame portions 234 and 244 in a state where the coupled two frame components 232 and 242 are distorted by a load. FIG. 11C(b) schematically shows the inner surface of the side frame portions 234 and 244 in a state where the coupled two frame components 232 and 242 are distorted by a load. FIG. 11D is an enlarged view of an important part of the inner surface of the side frame portions 234 and 244 in a state where the coupled two frame components 232 and 242 are distorted.

As shown in FIGS. 11A(a) and (b), the two frame components 232 and 242 can be coupled to each other at ends 250A/250B. In the end 250A of the outer surface of the side frame portion 234 of one of the frame components, i.e., the frame component 232, a stopper portion 252 having a stopper claw 252A is formed. In the end 250B of the outer surface of the side frame portion 244 of the other frame component 242, an engageable portion 254 for stopping the stopper claw 252A to be engaged with the stopper portion 252 is formed. In a front frame portion 243 of the other frame component 242, a member receiving portion 255 is provided. The member receiving portion 255 overlaps an end 253 of a front frame portion 233 of the one frame component 232 so as to support the end 253 from a rear side thereof.

As shown in FIGS. 11B(a) and (b), the engageable portion 254 is typically formed to be relatively large in order to provide a clearance. Therefore, even where the frame components 232 and 242 having the above-described structures are coupled to each other to form a coupling structure, the stopper claw 252A is movable in the engageable portion 254 (along the directions represented by the two-headed arrow in the figure). Because of this, the coupled frame components 232 and 242 are slightly movable to be away from (or to be close to) each other in accordance with the moving width of the stopper claw 252A.

When a frame 230 including the frame components 232 and 242 having the above-described structures is supplied with a load from the side of the front frame portions 233 and 243 toward the coupling part 250A/250B at which the frame components 232 and 242 are coupled to each other, as shown in FIG. 11C(b) and FIG. 11D, there is an undesirable possibility that the coupling part 250A/250B is pressed and the frame components 232 and 242 (especially the coupling part 250A/250B (and the proximal portion thereof) are bent. When the frame components 232 and 242 are bent like this, an edge of a tip of the member receiving portion 255 may contact an optical member 278 located on the rear side of the frame 230, more specifically, between the backlight device and the frame 230. Such a contact of the edge of the tip (typically, the edge contacts in a line-to-line manner) is not preferable because such a contact may damage the optical member 278 and reduce the display quality.

The present invention made in light of these points has a main object of providing a liquid crystal display device including a frame, formed of a plurality of frame components and located on the rear side of a liquid crystal panel, which prevents an optical member located on the rear side of the frame from being damaged.

### Solution to the Problem

In order to achieve the above-described object, a liquid crystal display device provided by the present invention comprises a liquid crystal panel having a rectangular shape; a frame of a frame-like shape located on a rear side of the liquid crystal panel; and a sheet-like optical member located on the rear side of the frame. The frame is formed of a plurality of frame components coupled to each other. In a coupling part of the frame components, a stopper portion provided in one of the frame components and an engageable portion provided in the other of the frame components are engaged with each other. When the engagement is realized, a part of an end of the one of the frame components and a part of an end of the other frame component overlap each other in a front-rear direction of the liquid crystal panel. Among the two overlapping ends, the end facing the optical member is formed to be contactable with the optical member in a surface-to-surface manner when the end becomes close to the optical member and the coupling part is bent toward the optical member.

In the liquid crystal display device according to the present invention, among the overlapping two ends, the end facing the optical member is close to the optical member. When the coupling part is bent to be closer to the optical member, the end facing the optical member is contactable with the optical member in a surface-to-surface manner. Owing to this, the optical member is prevented from being damaged by the contact with the end. Or, the degree of the damage can be significantly alleviated as compared with in the case where the edge at the tip contacts in a line-to-line manner as described above. Therefore, the present invention provides a preferable liquid crystal display device by which damage of an optical member which would otherwise be caused by a contact thereof with an end of a frame component in a frame component coupling part can be prevented or alleviated and thus the reduction of the display quality is effectively prevented.

In one preferable embodiment of the liquid crystal display device disclosed herein, among the two overlapping ends, the end facing the optical member is formed to be thick so that a surface thereof facing the optical member is close to the optical member.

According to the liquid crystal display device having such a structure, since the end is formed to be thick, a surface of the end facing the optical member can be easily close to the optical member and also can easily contact the optical member in a surface-to-surface manner.

In another preferable embodiment of the liquid crystal display device according to the present invention, among the two overlapping ends, the end facing the optical member has, on a surface thereof facing the optical member, an assisting member which is close to the optical member and has such a shape that is contactable with the optical member in a surface-to-surface manner when the coupling part is bent toward the optical member.

In the liquid crystal display device having such a structure, an assisting member is provided on a surface of the end facing the optical member. Owing to this, the surface of the end facing the optical member can be easily close to the optical member. In addition, when the coupling part is bent toward the optical member, the assisting member can easily contact the optical member in a preferable surface-to-surface manner without the frame component itself directly contacting the optical member.

In a more preferable embodiment of the liquid crystal display device having the above-described structure, the assisting member is formed of a material softer than the frame component.

In the liquid crystal display device having such a structure, the assisting member is formed of a soft material. Owing to this, the assisting member acts as a cushioning member between the frame component and the optical member, and thus can further improve the effect of preventing the optical member from being damaged.

The present invention provides, in another aspect, a frame which can be included in the liquid crystal display device disclosed herein. The frame for a liquid crystal display device is a frame of a frame-like shape included in a liquid crystal display device, which includes a liquid crystal panel having a rectangular shape and a sheet-like optical member, and located on a rear side of the liquid crystal panel and on a front side of the optical member. The frame is formed of a plurality of frame components coupled to each other. In a coupling part of the frame components, a stopper portion provided in one of the frame components and an engageable portion provided in the other of the frame components are engaged with each other. When the engagement is realized, a part of an end of the one of the frame components and a part of an end of the other frame component overlap each other in a front-rear direction of the liquid crystal panel. Among the two overlapping ends, the end facing the optical member is formed to be contactable with the optical member in a surface-to-surface manner when the end becomes close to the optical member and the coupling part is bent toward the optical member in a state where the end is located at a prescribed position of the liquid crystal display device.

By using the frame for a liquid crystal display device according to the present invention, the optical member can be prevented from being damaged by a contact thereof with the above-described end (e.g., a line-to-line contact with an edge). Or, the degree of the damage can is alleviated. Thus, a preferable liquid crystal display device providing a high display quality is provided.

In one preferable embodiment of the frame for a liquid crystal display device disclosed herein, among the two overlapping ends, the end facing the optical member is formed to be thick so that a surface thereof facing the optical member is close to the optical member in a state where the end is located at a prescribed position of the liquid crystal display device.

In the frame for a liquid crystal display device having such a structure, the end is formed to be thick. By using such a frame, a liquid crystal display device in which a surface of the end facing the optical member can be easily close to the optical member and also can easily contact the optical member in a surface-to-surface manner is provided.

In another preferable embodiment of the frame for a liquid crystal display device according to the present invention, among the two overlapping ends, the end facing the optical member has, on a surface thereof facing the optical member, an assisting member having a shape with which the assisting member is contactable with the optical member in a surface-to-surface manner when the end becomes close to the optical member and the coupling part is bent toward the optical member in a state where the end is located at a prescribed position of the liquid crystal display device.

In the frame for a liquid crystal display device having such a structure, an assisting member is provided on a surface of the end facing the optical member. By using such a frame, a liquid crystal display device in which the surface of the end facing the optical member can be easily close to the optical member is provided. In addition, a liquid crystal display device in which when the coupling part is bent toward the optical member, the assisting member can easily contact the optical member in a preferable surface-to-surface manner without the frame component itself directly contacting the optical member is provided.

In a more preferable embodiment of the frame for a liquid crystal display device having the above-described structure, the assisting member is formed of a material softer than the frame component.

By using the frame for a liquid crystal display device having such a structure, a liquid crystal display device having a further improved effect of preventing the optical member from being damaged is provided.

### BRIEF DESCRIPTION OF THE DRAWINGS

FIG. 1 is an exploded perspective view schematically showing a structure of a liquid crystal display device in an embodiment.

FIG. 2 is a cross-sectional view schematically showing the structure of the liquid crystal display device in the embodiment.

FIG. 3 is an exploded perspective view schematically showing a frame included in the liquid crystal display device in the embodiment.

FIG. 4 is an enlarged view of the IV part in FIG. 3, and is an exploded perspective view schematically showing a coupling structure of two frame components.

FIG. 5 shows the two frame components coupled to each other in the IV part in FIG. 3.

FIG. 6 is an enlarged view of the VI part in FIG. 3, and is an exploded perspective view schematically showing a coupling structure of two frame components.

FIG. 7 shows the two frame components coupled to each other in the VI part in FIG. 3.

FIG. 8 is an enlarged view of an important part of FIG. 7.

FIG. 9A is a perspective view schematically showing a member receiving portion in an altered example of a frame included in the liquid crystal display device in the embodiment.

FIG. 9B is a cross-sectional view mainly showing the member receiving portion in the state where two frame components are coupled to each other in the altered example of a frame included in the liquid crystal display device in the embodiment.

FIG. 10 is a perspective view showing a coupling part of two frame components in another altered example of a frame included in the liquid crystal display device in the embodiment.

FIG. 11A(a) schematically shows an outer surface of each of side frame portions of two frame components before a coupling structure is formed, and FIG. 11A(b) schematically shows an inner surface of each of the side frame portions of the two frame components before the coupling structure is formed.

FIG. 11B(a) schematically shows the outer surface of the side frame portions in a state where the coupling structure is formed and the two frame components are coupled to each other, and FIG. 11B(b) schematically shows the inner surface of the side frame portions in a state where the coupling structure is formed and the two frame components are coupled to each other.

FIG. 11C(a) schematically shows the outer surface of the side frame portions in a state where the coupled two frame components are distorted by a load, and FIG. 11C(b) schematically shows the inner surface of the side frame portions in a state where the coupled two frame components are distorted by a load.

FIG. 11D is an enlarged view of an important part of the inner surface of the side frame portions in a state where the coupled two frame components are distorted.

### DESCRIPTION OF EMBODIMENTS

Hereinafter, some preferable embodiment of the present invention will be described with reference to the drawings. Elements which are other than the elements specifically described in this specification (e.g., the structure of a frame) but are necessary to carry out the present invention (e.g., the structure and production method of the liquid crystal panel, the structure of a light source included in the liquid crystal display device, the electrical circuit used by the driving system of the light source, etc.) may be understood as being the matter of design choice determined by a person of ordinary skill in the art based on the conventional art. The present invention can be carried out based on the contents disclosed in this specification and the technological common knowledge in the art.

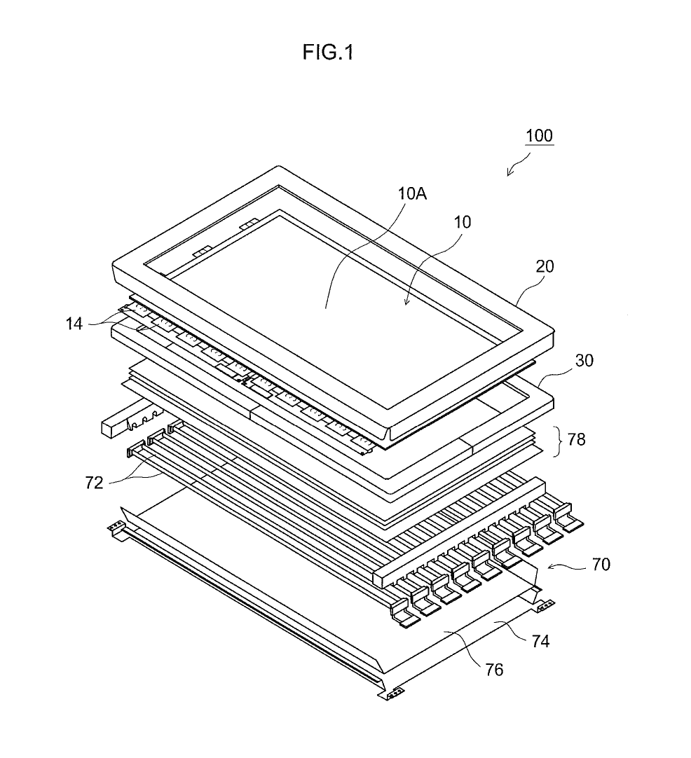

Hereinafter, with reference to FIG. 1 through FIG. 8, a liquid crystal display device 100 of an active matrix system (TFT type) including a liquid crystal panel 10 according to one preferable embodiment of the present invention will be described. In the figures referred to below, members or portions having the same functions may bear the same reference characters and descriptions thereof may not be repeated or may be simplified. In the figures, the relative sizes (length, width, thickness, etc.) do not necessarily reflect the actual relative sizes accurately. In the following description, the “front surface”, “top surface”, and “front side” mean the side of the liquid crystal display device 100 facing the viewer (i.e., the liquid crystal panel side), and the “rear surface”, “back surface”, and “rear side” mean the side of the liquid crystal display device 100 not facing the viewer (i.e., the backlight device side).

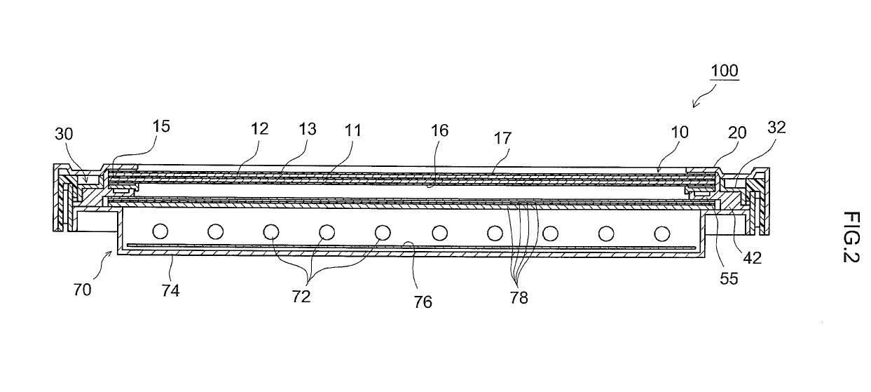

With reference to FIG. 1 and FIG. 2, a structure of the liquid crystal display device 100 will be described. As shown in FIG. 1, the liquid crystal display device 100 includes the liquid crystal panel 10 and a backlight device 70, which is an external light source located on the rear side of the liquid crystal panel 10 (lower side in FIG. 1). The liquid crystal panel 10 and the backlight device 70 are integrally held by being assembled by a bezel 20 or the like.

As shown in FIG. 1 and FIG. 2, the liquid crystal panel 10 has a generally rectangular overall shape. In a central area of the liquid crystal panel 10, a display area 10A including pixels for displaying an image is formed. The liquid crystal panel 10 has a sandwich structure including a pair of light-transmissive glass substrates 11 and 12 facing each other and a liquid crystal layer 13 confined therebetween. As each of the substrates 11 and 12, a substrate cut from a large mother member called “mother glass” during a production process thereof is used. Among the pair of substrates 11 and 12, the substrate on the front side is a color filter substrate (CF substrate) 12, and the substrate on the rear side is an array substrate 11. On a peripheral portion of each of the substrates 11 and 12 (the peripheral portion of the liquid crystal panel 10), a sealant 15 is provided so as to surround the perimeter of the display area 10A. The sealant 15 confines the liquid crystal layer 13. The liquid crystal layer 13 is formed of a liquid crystal material containing liquid crystal molecules. The orientation of the liquid crystal molecules in such a liquid crystal material is controlled by an electric field applied between the substrates 11 and 12, and thus the optical characteristics of the liquid crystal material are changed. In the liquid crystal layer 13, a spacer (not shown) for providing a thickness (gap) of the layer 13 is located, typically at a plurality of positions. On surfaces of the substrates 11 and 12 facing each other (inner surfaces), alignment films (not shown) for determining the orientation of the liquid crystal molecules are respectively formed. On surfaces of the substrates 11 and 12 not facing each other (outer surfaces), polarizer plates 16 and 17 are respectively bonded.

In the liquid crystal panel 10 disclosed herein, the pixels (more precisely, sub pixels) for displaying an image are arranged in the array substrate 11 on the front side thereof (side facing the liquid crystal layer 13). The liquid crystal panel 10 also includes a plurality of source lines and a plurality of gate lines (not shown) for driving each of the pixels (sub pixels) in a grid pattern. In each of the grid areas surrounded by these lines, a (sub) pixel electrode and a thin film transistor (TFT) acting as a switching element are provided. Typically, the pixel electrode is formed of ITO (Indium Tin Oxide), which is a transparent conductive material. The pixel electrodes are supplied with a voltage in accordance with the image at a prescribed timing via the source lines and the thin film transistors

In the CF substrate 12, a color filter of one of the colors of R (red), G (green) and B (blue) faces each one of the pixel electrodes provided in the array substrate 11. The CF substrate 12 also includes a black matrix for partitioning the color filters of these colors from each other, and a common electrode (transparent electrode) formed uniformly on a surface of the color filters and the black matrix.

As shown in FIG. 1, the source lines and the gate lines are typically connected to external circuits (driver ICs) 14, provided in the peripheral portion of the liquid crystal panel 10, which can supply image signals and the like.

The structure of the pixels and the wiring of the electrodes described above may be substantially the same as those for producing a conventional liquid crystal panel and do not characterize the present invention, and so will not be described in more detail.

As shown in FIG. 1 and FIG. 2, the backlight device 70 located on the rear side (back side) of the liquid crystal panel 10 includes a plurality of linear light sources (e.g., fluorescent tubes, typically, cold-cathode fluorescent tubes) 72 and a case (chassis) 74 for accommodating the light sources 72. The case 74 has a shape of box opened toward the front side. The light sources 72 are arranged parallel to each other in the case 74. A reflective member 76 for reflecting light from the light sources 72 toward the viewer's side efficiently is provided between the case 74 and the light sources 72.

In the opening of the case 74, a plurality of sheet-like optical members 78 are stacked and located so as to cover the opening. The optical members 78 are, for example, a diffuser, a diffusion sheet, a lens sheet and a luminance increasing sheet which are located sequentially in this order from the backlight device 70 side toward the liquid crystal panel 10 side. The optical members 78 are not limited to being this combination of elements or being located in this order. The case 74 is further provided with a frame 30 having a generally frame-like shape in order to hold the optical members 78 in the state where the optical members 78 are fit into the case 74. On the rear side of the case 74, an inverter circuit board (not shown) on which an inverter circuit is mounted and an inverter transducer (not shown) as a booster circuit for supplying power to each of the light sources 72 are provided, but these elements do not characterize the present invention and so will not be described.

As described above, the optical members 78 are located on the front side of the backlight device 70. The frame 30 having an opening in an area corresponding to the display area 10A of the liquid crystal panel 10 is mounted on the front side of the optical members 78 so that the optical members 78 are held by the frame 30 and the backlight device 70. On the front side of the frame 30, the liquid crystal panel 10 is placed on a front portion 30A (see FIG. 3) of the frame 30. Also on the front side of the liquid crystal panel 10, the bezel 20 of a frame-like shape is mounted. The liquid crystal panel 10 is typically located between the bezel 20 and the frame 30 and is held therebetween via, for example, a cushioning member (not shown) of an elastic material such as rubber, elastomer or the like.

The liquid crystal display device 100 of the above-described structure including the liquid crystal panel 10, the backlight device 70 and the like controls the liquid crystal molecules in the liquid crystal layer 13 by applying a controlled voltage to the array substrate 11 and the CF substrate 12, and passes or blocks light from the backlight device 70 by the liquid crystal panel 10. The liquid crystal display device 100 displays a desired image in the display area 10A of the liquid crystal panel 10 while controlling the luminance or the like of the backlight device 70.

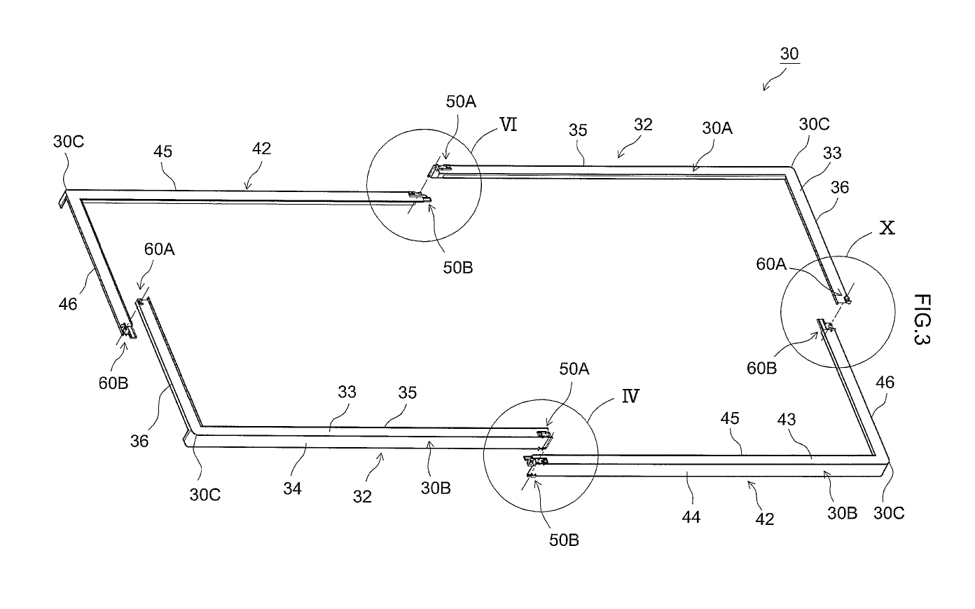

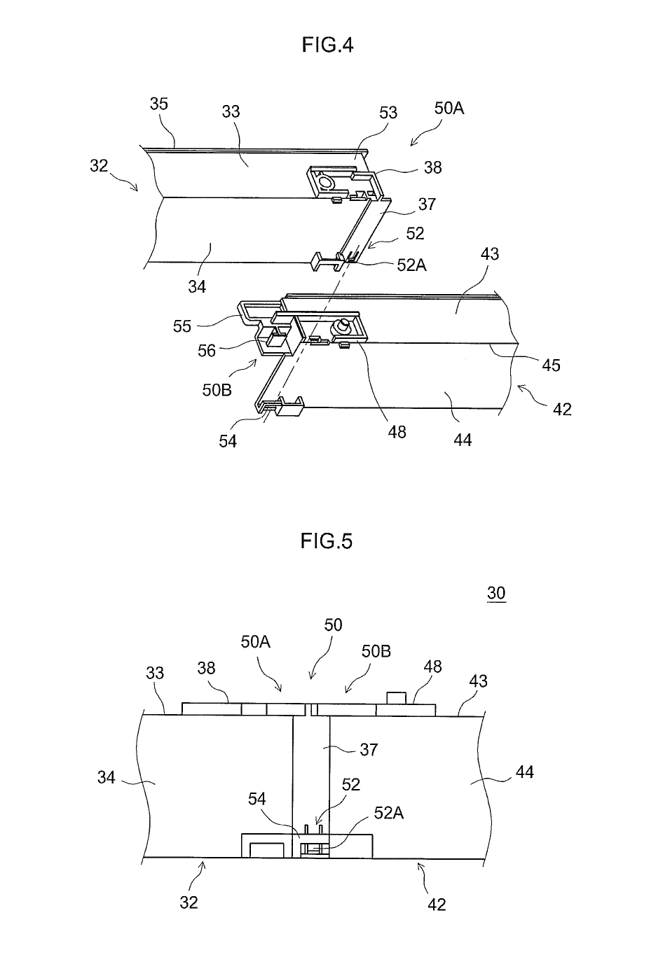

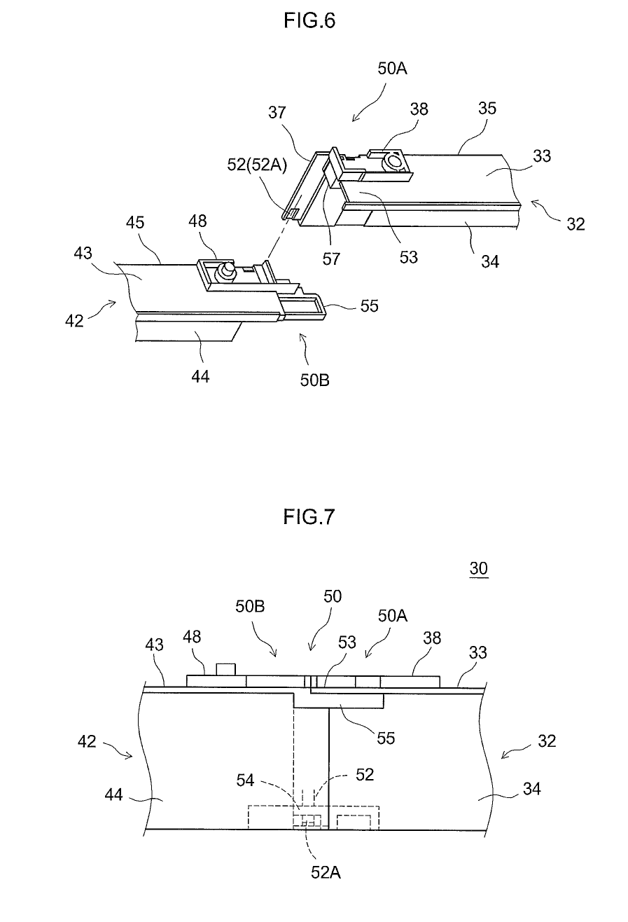

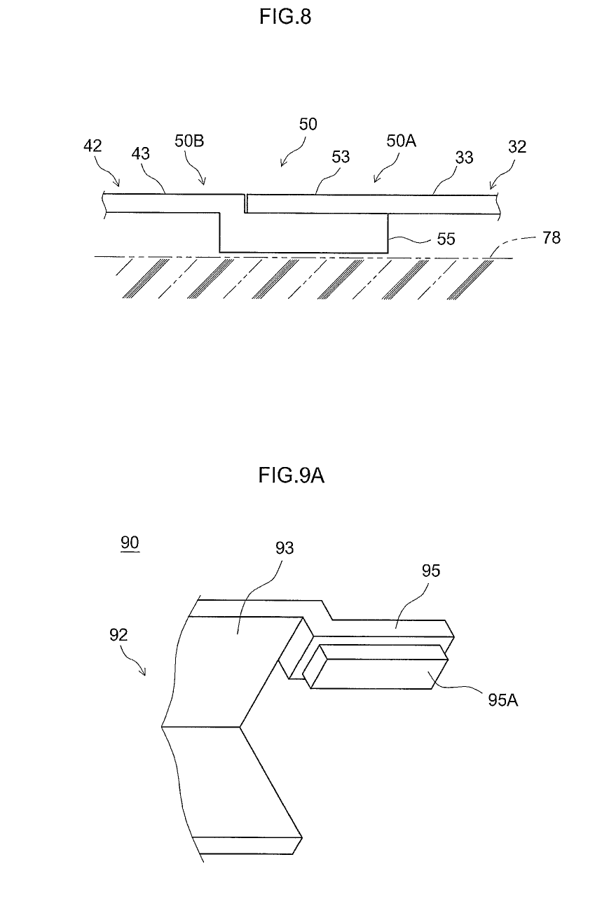

Now, with reference to FIG. 3 through FIG. 8, the structure of the frame 30 of the liquid crystal display device 100 in this embodiment will be described in more detail. FIG. 3 is an exploded perspective view schematically showing the frame 30 included in the liquid crystal display device 100. FIG. 4 is an enlarged view of the IV part in FIG. 3, and is an exploded perspective view schematically showing a coupling structure 50 of two frame components 32 and 42. FIG. 5 shows the two frame components 32 and 42 coupled to each other in the IV part in FIG. 3. FIG. 6 is an enlarged view of the VI part in FIG. 3, and is an exploded perspective view schematically showing the coupling structure 50 of two frame components 32 and 42. FIG. 7 shows the two frame components 32 and 42 coupled to each other in the VI part in FIG. 3. FIG. 8 is an enlarged view of an important part of FIG. 7.

As shown in FIG. 3, the frame 30 in this embodiment is located on the rear side of the liquid crystal panel 10. The frame 30 is a component which has a frame-like shape as seen in a plan view and is formed so as to surround the rectangular display area 10A located in a central area of the liquid crystal panel 10. The frame 30 is structured to hold the peripheral portion of the display area 10A (rectangular-like peripheral portion) together with the bezel 20, which is located on the front side of the liquid crystal panel 10 so as to surround the rectangular display area 10A. The frame 30 has the front portion 30A which contacts a rear surface of the panel when the liquid crystal panel 10 is mounted thereon and a side portion 30B extending from the front portion 30A perpendicularly thereto to cover side surfaces of longer sides of the rectangular-like peripheral portion (i.e., of the four sides surrounding the rectangular display area 10A). The frame 30 having such an overall structure is formed of four frame components 32 and 42, each of which has a shape obtainable by dividing the rectangular-like peripheral portion into four. Namely, the frame 30 of the frame-like shape described above is formed by coupling the four frame components 32 and 42 to each other.

As shown in FIG. 3, each of the frame components 32 and 42 has a shape obtainable by dividing the frame 30 into four at generally the central point of each of the four sides of the rectangular frame 30, and thus has an L-shape including each one corner of the four corners of the frame 30 as seen in a plan view. The frame components 32 and 42 respectively include front frame portions 33 and 43 which form the front portion 30A of the frame 30, and side frame portions 34 and 44 which form the side portion 30B of the frame 30. The front frame portions 33 and 43 and the side frame portions 34 and 44 may have a plurality of openings (e.g., rectangular openings) arranged at a prescribed interval in order to, for example, improve the efficiency of releasing the heat generated when the liquid crystal panel 10 is driven and/or to reduce the cost of the material, although such openings are not shown.

The frame component 32 includes a long side portion 35 forming the longer side of the four sides of the rectangular-like frame 30 (precisely, half of the longer side) and a short side portion 36 forming the shorter side of the four sides of the frame 30 (precisely, half of the shorter side). The frame component 32 has a corner 30C, which is one of the four corners of the frame 30, made by the long side portion 35 and the short side portion 36 crossing each other perpendicularly. An end of the long side portion 35 which does not form the corner 30C is a coupling part 50A to be coupled to a coupling part 50B of the frame component 42 to form the coupling structure 50. An end of the short side portion 36 which does not form the corner 30C is a coupling part 60A to be coupled to a coupling part 60B of the frame component 42 to form the coupling structure 60.

The frame component 42 includes a long side portion 45 forming the longer side of the four sides of the frame 30 and a short side portion 46 forming the shorter side of the four sides of the frame 30. The frame component 42 has a corner 30C, which is one of the four corners of the frame 30, made by the long side portion 45 and the short side portion 46 crossing each other perpendicularly. An end of the long side portion 45 which does not form the corner 30C is a coupling part 50B to be coupled to the coupling part 50A of the frame component 32 to form the coupling structure 50. An end of the short side portion 46 which does not form the corner 30C is a coupling part 60 B to be coupled to the coupling part 60A of the frame component 32 to form the coupling structure 60.

Two frame components 32 and two frame components 42 having such structures are located such that the same type of frame components face each other diagonally, and thus a rectangular-like frame shape is formed. The frame 30 is assembled by coupling the coupling parts 50A and 50B at the ends of the frame components 32 and 42 and coupling the coupling parts 60A and 60B at the ends of the frame components 32 and 42.

Now, with reference to FIG. 4 through FIG. 8, the coupling structure 50 formed of the coupling part 50A provided at the end of the long side portion 35 of the frame component 32 and the coupling part 50B provided at the end of the long side portion 45 of the frame component 42 will be described.

As shown in FIG. 4, the side frame portion 34 of the frame component 32 has, in the coupling part 50A, a protrusion 37 slightly protruding along the direction of the longer side from an end surface of the front frame portion 33. The protrusion 37 has a stopper portion 52 in an outer edge part thereof. In this embodiment, the stopper portion 52 has a stopper claw 52A, but the structure (shape) of the stopper portion 52 is not specifically limited. The stopper portion 52 may have, for example, a shape of a generally cylindrical protruding engageable portion 62 which can act as a stopper portion in the coupling structure 60 shown in FIG. 10. As shown in FIG. 4, an inner edge part of the end of the front frame portion 33 acts as an overlapping portion 53 which overlaps a member receiving portion 55, described below, when the frame components 32 and 42 are coupled to each other.

As shown in FIG. 4, the side frame portion 44 of the frame component 42 has, in the coupling part 50B, an engageable portion 54 in an outer edge part thereof. The engageable portion 54 is engageable with the stopper portion 52 (stopper claw 52A), and is provided at a position which overlaps the protrusion 37 when the frame components 32 and 42 are coupled to each other. There is no specific limitation on the shape of the engageable portion 54 as long as the engageable portion 54 is engaged with the stopper portion 52 to realize the coupling of the frame components 32 and 42 with certainty. The engageable portion 54 may have, for example, a shape of an engageable hole 64 which can act as an engageable portion in the coupling structure 60 shown in FIG. 10. Preferably, the engageable portion 54 is slightly larger than the stopper portion 52. An appropriate size of the engageable portion 54 is sufficiently large to form a clearance preferable for making it easier to couple the frame components 32 and 42 to each other via the engageable portion 54 (i.e., for making it easier to engage the stopper portion 52 with the engageable portion 54). A preferable size of the clearance is such that even when, for example, the frame components 32 and 42 are thermally contracted, the stopper portion 52 can be easily engaged with the engageable portion 54.

As shown in FIG. 4 and FIG. 6, in the coupling part 50B of the frame component 42, the member receiving portion 55 having a generally parallelepiped shape is formed to protrude from an end of the inner edge part of the front frame portion 43 along the direction of the longer side. The member receiving portion 55 faces the optical member 78 located on the rear side of the frame 30. As shown in FIG. 7, a top surface of the member receiving portion 55 is recessed from the front frame portion 43 by a depth corresponding to the thickness of the overlapping portion 53 (or the front frame portion 33 of the frame component 32). However, the overall thickness of the member receiving portion 55 is larger than the thickness of the front frame portion 43 (and of the front frame portion 33 of the frame component 32).

The length of the member receiving portion 55 in the protruding direction is appropriately set based on the balance between the strength against the load applied on the member receiving portion 55 when the frame components 32 and 42 are coupled to each other and thus the member receiving portion 55 and the overlapping portion 53 overlap each other, and the contact (overlapping) area size of the member receiving portion 55 and the overlapping portion 53 with which the coupling state of the frame components 32 and 42 can be stably maintained.

As shown in FIG. 8, an appropriate thickness of the member receiving portion 55 corresponds to a gap between the optical member 78 and a rear surface of the overlapping portion 53. A preferable thickness of the member receiving portion 55 is such that a rear surface of the member receiving portion 55 (i.e., the surface facing the optical member 78) is close to the optical member 78. In this embodiment, the member receiving portion 55 has a shape by which the top surface is recessed at a central portion thereof as compared with a peripheral portion thereof, but the member receiving portion 55 is not limited to having such a shape. The member receiving portion 55 may have, for example, a simple parallelepiped shape with no recess at a central portion thereof (like a brick). Alternatively, the member receiving portion 55 may have a recess at a central portion thereof and a cushioning member may be located in (typically, fit into) the recess.

For coupling the coupling part 50A of the frame component 32 and the coupling part 50B of the frame component 42 having the above-described structures to form the coupling structure 50, as shown in FIG. 4 and FIG. 6, the frame component 32 and the frame component 42 are connected to each other such that the coupling part 50A and the coupling part 50B overlap each other. At this point, as shown in FIG. 5, in the side portion 30B of the frame 30, the protrusion 37 in the coupling part 50A overlaps the side frame portion 44 in the coupling part 50B and so the stopper claw 52A of the protrusion 37 is engaged with the engageable portion 54 of the side frame portion 44. In the front portion 30A of the frame 30, as shown in FIG. 7, a rear surface of the overlapping portion 53 in the coupling part 50A overlaps, and is supported by, the member receiving portion 55 in the coupling part 50B. In this manner, the coupling structure 50 is formed to couple the frame components 32 and 42 to each other. In FIG. 4, reference character 56 represents a protruding engageable portion in the coupling part 50B. In FIG. 6, reference character 57 represents a recessed engageable portion, formed adjacent to the overlapping portion 53 in the coupling part 50A, to correspond to the protruding engageable portion 56. The protruding engageable portion 56 is engaged with the recessed engageable portion 57 when the frame components 32 and 42 are coupled to each other. This engagement can reinforce the coupling of the frame components 32 and 42 and maintain the coupling structure 50 stably. In FIG. 4 and FIG. 6, reference characters 38 and 48 represent fixing portions for fixing the bezel 20, located on a top surface of the frame 30, to the frame 30.

In the coupling structure 50 formed as described above, the member receiving portion 55 is formed to be thicker than the front frame portion 33. This provides the following effect. As shown in FIG. 8, the member receiving portion 55 is thick and so is close to the optical member 78 located on the rear side of the frame 30 formed of the frame components 32 and 42. Typically because of the clearance provided in the engageable portion 54, the stopper portion 52 engaged with the engageable portion 54 can slightly move in the engageable portion 54. Because of this, the frame components 32 and 42 may be bent (distorted) around the coupling part 50A/50B acting as the center of bending, and so the member receiving portion 55 may contact the optical member 78. However, the contact of the member receiving portion 55 and the optical member 78 is not a line-to-line contact only along the edge as described above, but is a surface-to-surface contact (i.e., a bottom surface of the member receiving portion 55 (the surface facing the optical member) contacts the optical member 78 over a wide range). Therefore, the contact area size of the member receiving portion 55 and the optical member 78 is larger than in the case of a line-to-line contact. The contact area of the member receiving portion 55 does not have such an acute shape that significantly damages the optical member 78. Thus, the large thickness of the member receiving portion 55 can prevent the optical member 78 from being damaged by the contact with the member receiving portion 55. Even when the liquid crystal display device is significantly vibrated during the transportation or the like, the degree of the damage which may be given by the contact with the member receiving portion 55 can be alleviated significantly. Accordingly, the reduction in the display quality of the liquid crystal panel 10 can be prevented.

The coupling structure 60 formed by the coupling part 60A provided at the end of the short side portion 36 of the frame component 32 and the coupling part 60B provided at the end of the short side portion 46 of the frame component 42 may have a similar structure to that of the coupling structure 50. Alternatively, the coupling structure 60 may be formed, for example, by an engagement of a protruding engageable portion and an engageable hole respectively provided in the coupling parts 60A and 60B. More specifically, in this embodiment, as shown in FIG. 10, the coupling part 60A of the frame component 32 has an engageable hole 64 in an outer edge part of the front frame portion 33. In an inner edge part of the front frame portion 33, an overlapping portion 63 is located adjacent to the engageable hole 64. The coupling part 60B of the frame component 42 has a protruding engageable portion 62 (which is, for example, cylindrical), engageable with the engageable hole 64, in an outer edge part of the front frame portion 43. In an inner edge part of the front frame portion 43, a member receiving portion 65 is located adjacent to the protruding engageable portion 62. When the coupling structure 60 is formed (when the frame components 32 and 42 are coupled to each other), the member receiving portion 65 is located on the rear side of the overlapping portion 63 and thus overlaps the overlapping portion 63. Like the member receiving portion 55, the member receiving portion 65 preferably has a large thickness in order to provide substantially the same effect as that of the member receiving portion 55 (the effect of preventing the optical member 78 from being damaged). In this embodiment, on a top surface of the member receiving portion 65, a cushioning member 65A is provided in two lines.

For coupling the coupling part 60A of the frame component 32 and the coupling part 60B of the frame component 42 having the above-described structures to form the coupling structure 60, the frame component 32 and the frame component 42 are connected to each other such that the coupling part 60A and the coupling part 60B overlap each other. At this point, as shown in FIG. 10, the coupling part 60A overlaps the coupling part 60B. The protruding engageable portion 62 in the coupling part 60B is inserted into the engageable hole 64 in the coupling part 60A, and the protruding engageable portion 62 and the engageable hole 64 are engaged with each other. At this point, a rear surface of the overlapping portion 63 in the coupling part 60A contacts, and is supported by, the member receiving portion 65 (the top surface of the member receiving portion 65) in the coupling part 60B. In this manner, the coupling structure 60 is formed to couple the frame components 32 and 42 to each other.

In this manner, as shown in FIG. 3, two coupling structures 50 and two coupling structures 60 are formed, and thus the two frame components 32 and the two frame components 42 are coupled to each other. Thus, the frame 30 can be constructed (assembled).

A method for producing the liquid crystal display device 100 including the frame 30 may be the same as the conventional method, and there is no specific limitation on the method. One example of production method is as follows. First, the liquid crystal panel 10 is prepared (produced). More specifically, the array substrate 11 including an array of TFTs formed on a glass substrate and the CF substrate 12 including the color filters are first produced using, for example, photolithography. Next, the resin sealant 15 is formed so as to surround the peripheral portion of the array substrate 11, and spacers (not shown) are dispersed on the array substrate 11, so that a prescribed gap is made between the array substrate 11 and the CF substrate 12 when the substrates are put together. Then, the array substrate 11 and the CF substrate 12 are bonded together such that the surfaces thereof having the alignment films (not shown) face each other. Next, the pair of substrates 11 and 12 bonded together are kept vacuum, and a liquid crystal material is injected into the gap between the substrates by means of capillary action. After the gap is filled with the liquid crystal material, the injection opening is sealed. Finally, the polarizer plates 16 and 17 are bonded to the surfaces of the substrates 11 and 12 which do not face each other. Thus, the liquid crystal panel 10 is completed.

On the rear side of the completed liquid crystal panel 10, the frame 30 constructed as above is located. On the rear side of the frame 30, the optical members 78 and the backlight device 70 accommodated in the case 74 are mounted. On the front side of the liquid crystal panel 10, the bezel 20 is located. While the liquid crystal panel 10 is held between the frame 30 and the bezel 20, all of the liquid crystal panel 10, the frame 30 and the backlight device 70 are assembled. Thus, the liquid crystal display device 100 is completed.

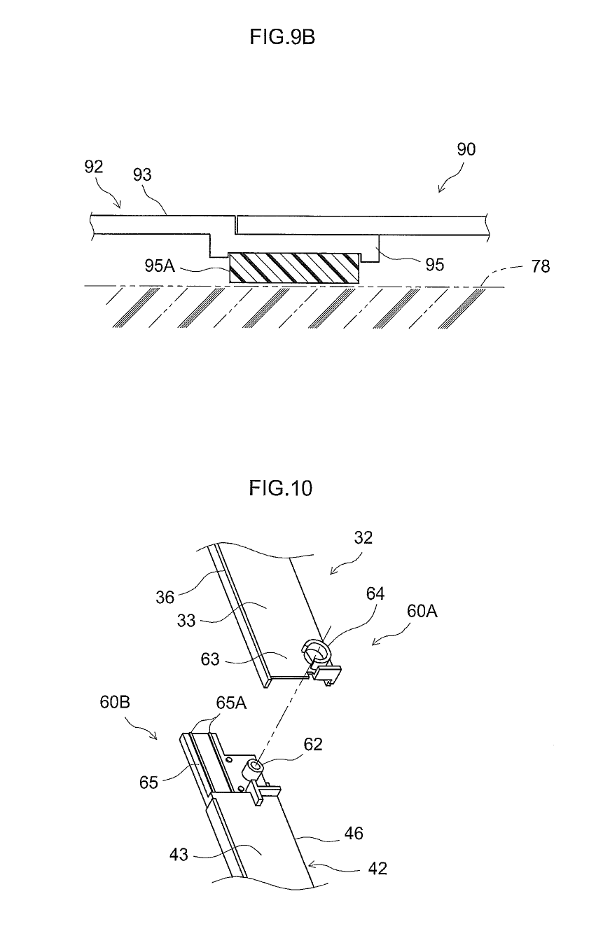

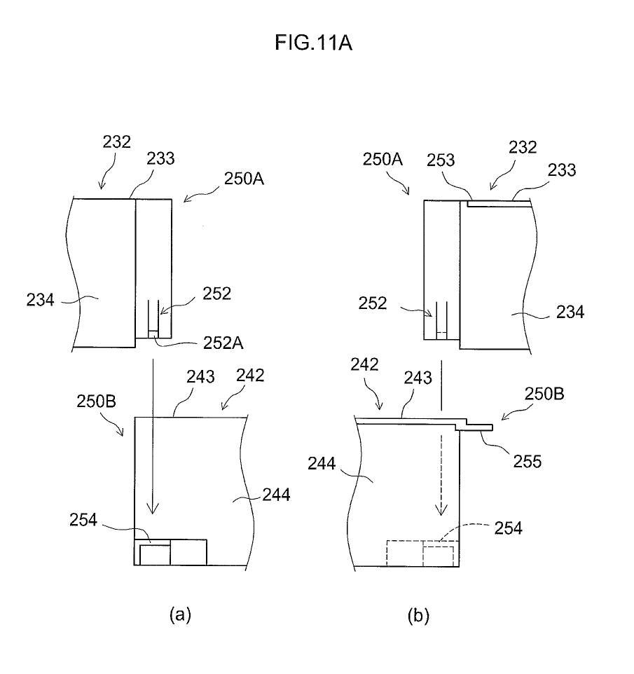

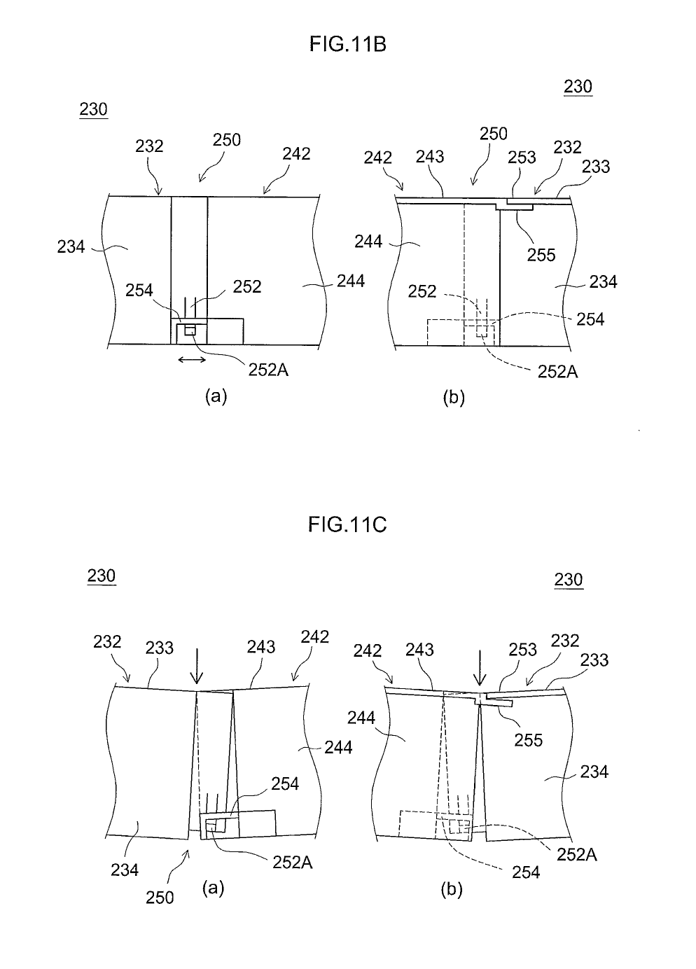

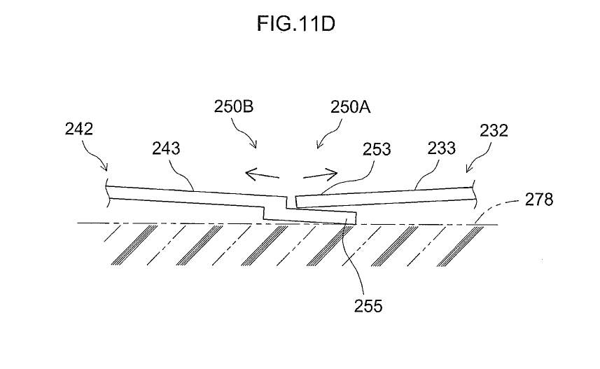

The present invention has been described so far by way of a preferable embodiment, but the above descriptions are not limiting the present invention, and the present invention may be altered in many ways, needless to say. For example, in the above embodiment, the frame 30 is formed of two of two types of components 32 and 42, each of which is obtainable by dividing the frame 30 into four. For example, the frame may be formed of two generally C-shaped frame components, which are obtainable by dividing the frame into two. The frame may include, for example, an assisting member provided on the rear surface of the member receiving portion. More specifically, as shown in FIG. 9A and FIG. 9B, a frame 90 according to an altered example includes a frame component 92 as one element. The frame component 92 includes a front frame portion 93 acting as a front surface on which a liquid crystal panel is located and which contacts the rear surface of the liquid crystal panel. At an end of an inner edge part of the front frame portion 93, a member receiving portion 95 is provided. On a rear surface of the member receiving portion 95, an assisting member 95A (having, for example, a parallelepiped shape) is fixed. Owing to the assisting member 95A, the member receiving portion 95 in the frame 90 has approximately the same thickness as that of the member receiving portion 55 in the above embodiment. Since the frame 90 includes the member receiving portion 95 having the assisting member 95A, a coupling part (member receiving portion 95) of the frame component 92 and another frame component (not shown) can be close to the optical member 78. When the coupling part is bent toward the optical member 78, the assisting member 95A in the coupling part (member receiving portion 95) can contact the optical member 78 in a surface-to-surface manner. Preferably, the assisting member 95A is formed of a material softer than the frame component 92 (e.g., an elastic material such as rubber, elastomer or the like). The assisting member 95A formed of a material softer than the frame component 92 contacts the optical member 78 located on the rear side of the frame 90 and can act as a preferable cushioning member between the frame 90 (frame component 92) and the optical member 78. Accordingly, the effect of preventing the optical member 78 from being damaged by the contact with the frame 90 can be realized with a higher level of performance.

### INDUSTRIAL APPLICABILITY

The present invention can realize a preferable liquid crystal display device including a frame formed of a plurality of frame components and located on the rear side of a liquid crystal panel, by which damage of an optical member which would otherwise be caused by a contact thereof with an end of any of the frame components in a frame component coupling part can be prevented or alleviated and thus the reduction of the display quality is effectively prevented.

### DESCRIPTION OF REFERENCE CHARACTERS

10 Liquid crystal panel
10A Display area
11 Array substrate
12 Color filter (CF) substrate
13 Liquid crystal layer
14 External driving circuit
15 Sealant
16, 17 Polarizer plate
20 Bezel
30 Frame
30A Front portion
30B Side portion
30C Corner
32 Frame component
33 Front frame portion
34 Side frame portion
35 Long side portion
36 Short side portion
37 Protruding portion
42 Frame component
43 Front frame portion
44 Side frame portion
45 Long side portion
46 Short side portion
50 Coupling structure
50A, 50B Coupling part
52 Stopper portion
52A Stopper claw
53 Overlapping portion
54 Engageable portion
55 Member receiving portion
60 Coupling structure
60A, 60B Coupling part
62 Protruding engageable portion
63 Overlapping portion
64 Engageable hole
65 Member receiving portion
65A Cushioning member
70 Backlight device
72 Light source
74 Case
76 Reflective member
78 Optical member
90 Frame
92 Frame component
93 Front frame portion
95 Member receiving portion
95A Assisting member
100 Liquid crystal display device

1. A liquid crystal display device, comprising:
a liquid crystal panel having a rectangular shape;
a frame of a frame-like shape located on a rear side of the liquid crystal panel; and
a sheet-like optical member located on the rear side of the frame;
wherein:
the frame is formed of a plurality of frame components coupled to each other;
in a coupling part of the frame components, a stopper portion provided in one of the frame components and an engageable portion provided in the other of the frame components are engaged with each other, and when the engagement is realized, a part of an end of the one of the frame components and a part of an end of the other frame component overlap each other in a front-rear direction of the liquid crystal panel; and
among the two overlapping ends, the end facing the optical member is formed to be contactable with the optical member in a surface-to-surface manner when the end becomes close to the optical member and the coupling part is bent toward the optical member.

2. The liquid crystal display device of claim 1, wherein among the two overlapping ends, the end facing the optical member is formed to be thick so that a surface thereof facing the optical member is close to the optical member.

3. The liquid crystal display device of claim 1, wherein among the two overlapping ends, the end facing the optical member has, on a surface thereof facing the optical member, an assisting member having a shape with which the assisting member is contactable with the optical member in a surface-to-surface manner when the end becomes close to the optical member and the coupling part is bent toward the optical member.

4. The liquid crystal display device of claim 3, wherein the assisting member is formed of a material softer than the frame component.

5. A frame of a frame-like shape for a liquid crystal display device including a liquid crystal panel having a rectangular shape and a sheet-like optical member, the frame being located on a rear side of the liquid crystal panel and on a front side of the optical member, wherein:
the frame is formed of a plurality of frame components coupled to each other;
in a coupling part of the frame components, a stopper portion provided in one of the frame components and an engageable portion provided in the other of the frame components are engaged with each other, and when the engagement is realized, a part of an end of the one of the frame components and a part of an end of the other frame component overlap each other in a front-rear direction of the liquid crystal panel; and
among the two overlapping ends, the end facing the optical member is formed to be contactable with the optical member in a surface-to-surface manner when the end becomes close to the optical member and the coupling part is bent toward the optical member in a state where the end is located at a prescribed position of the liquid crystal display device.

6. The frame of claim 5, wherein among the two overlapping ends, the end facing the optical member is formed to be thick so that a surface thereof facing the optical member is close to the optical member in a state where the end is located at a prescribed position of the liquid crystal display device.

7. The frame of claim 5, wherein among the two overlapping ends, the end facing the optical member has, on a surface thereof facing the optical member, an assisting member having a shape with which the assisting member is contactable with the optical member in a surface-to-surface manner when the end becomes close to the optical member and the coupling part is bent toward the optical member in a state where the end is located at a prescribed position of the liquid crystal display device.

8. The frame of claim 7, wherein the assisting member is formed of a material softer than the frame component.
